(19) United States
(12) Patent Application Publication
(10) Pub. No.: US 2004/0179471 A1
(43) Pub. Date: Sep. 16, 2004

(54) Bi-directional flow-switched ring

(76) Inventors: Adisak Mekkittikul, Mountain View, CA (US); Nader Vijeh, Sunnyvale, CA (US)

Correspondence Address: WAGNER, MURABITO & HAO LLP, Two North Market Street, Third Floor, San Jose, CA, 95113, US

(21) Appl. No.: 09/801,533

(22) Filed: Mar. 7, 2001

(51) Int. Cl. H04L 12/56; H04J 3/14

(52) U.S. Cl. 370/218; 370/404

(57) ABSTRACT

A bi-directional flow-switched packet ring protection scheme. A primary ring is the ring upon which a flow is sent unless a failure prevents it from reaching its destination node. A secondary ring is the other ring (one of the dual counter-rotating rings) on which the flow can be switched to in the event of failure to the primary ring. In a normal mode of operation, both the primary and secondary rings are functioning properly. However, if there is a failure on the primary ring, this failure is broadcast to all nodes, identifying the failed connection. These nodes then immediately redirect the flows that are affected by the ring failure onto the secondary ring. When the failure condition is removed, all sources must switch their redirected flows back on to the primary ring.

### FIELD OF THE INVENTION

The present invention relates to a packet network having a bi-directional flow-switched ring.

### BACKGROUND OF THE INVENTION

Businesses and individuals rely upon data networks for communications and the exchange of information. Computers coupled to these data networks allow users to readily gain access to and exchange data of all types (e.g., sound, text, numerical data, video, graphics, multi-media, etc.) with other computers, databases, websites, etc. Generally, data is transmitted and routed as packets over these networks. Referring to FIG. 1, a simple packet-switched network is shown. The nodes 101-106 represent network elements (e.g., routers, hubs, switches, etc.) coupled to the network. One node can transmit packetized data to and receive packetized data from any of the other nodes also coupled to the network. A data packet can be routed via one or more intermediary nodes before reaching its final destination. For example, suppose that node 101 is the source, and node 102 is the destination. A data packet is generated by node 101 and transmitted from node 101 to node 104 via link 107. Upon receipt of this data packet, node 104 examines it and then forwards it on to node 106 via link 108.

One advantage of implementing a packet network of this configuration is its robustness and reliability. If a link is broken or otherwise becomes non-functional, an alternative path can be found to send the data packet to its destination. As an example, given that link 108 fails and cannot carry data, node 101 can nonetheless successfully transmit a data packet to destination 106. The data packet can be sent first to node 102 via link 109; then forwarded to node 103 via link 110; and lastly, to node 106 via link 111. Unfortunately, it can take an exceedingly long time to restore a packet in the case of a downed link. It can take up to one second to restore a packet. In some applications (e.g., email), this delay is negligible. However, a second's delay is totally unacceptable for real-time applications, such as voice communications, video transmissions, etc. Furthermore, as more nodes are added onto the network, it can be quite complex and costly to maintain, direct, and route these packets.

A much simpler and more cost-effective scheme entails protecting packets by using a ring topology configuration. FIG. 2 shows a simple ring topology. In a ring topology, data packets are transmitted from one node to the next downstream node. For instance, node 201 can transmit a data packet to node 207 as follows. A data packet enters node 201. Node 201 immediately forwards the data packet to node 202 via link 208. Node 202 examines the data packet, determines that the data packet is not intended for it, and immediately forwards that data packet onto the next downstream node 203. This data packet is successively examined and forwarded by nodes 204-206 via links 210-212. Lastly, node 206 forwards the data packet to destination node 207 via link 213. The data packet can now be output from the ring via node 207.

Oftentimes, a second ring transmitting packets in the opposite direction is added to provide a degree of fault protection and also to increase network bandwidth. Referring still to FIG. 2, a second ring comprised of links 215-220, running in a counter-clockwise direction, is shown. By implementing a counter-rotating second ring, a single point of failure will not prevent any node from exchanging data packets with any other node on that network. This is due to the fact that if a single failure occurs in one of the rings, the other ring can be used to convey data packets for all nodes.

FIG. 3 shows an exemplary method by which the prior art ring topology routes data packets in case of a single point failure occurs in a primary ring. In this example, suppose that an packet input to node 301 is destined for output on node 307. Normally, this packet would be routed on the primary clockwise ring (e.g., segments 308-313). However, if link 313 fails, then the data packet is prevented from reaching its destination via the primary ring. In this case, the packet is rerouted onto the secondary, counter-clockwise ring and successfully sent to the destination. In other words, node 306 switches the packet onto the counter-clockwise ring. The packet travels through links 317-322 to reach node 307. This is commonly referred to as a “loopback.” Although, the packet is successfully looped back, it must traverse through additional links to reach its intended destination.

The ring topology described above has gained widespread popularity due to its relative simplicity and low cost. The basic loopback failure recovery scheme of the ring topology design has existed in its present state for quite some time now. However, the standard loopback scheme is relatively inefficient for and incompatible with data networks. Therefore, there exists a need for improving the way by which failures in ring topologies are handled. The present invention offers unique and novel ways by which failure detection and recovery on ring topologies can be made even more effectively and robust.

### SUMMARY OF THE INVENTION

The present invention pertains to a bi-directional flow-switched packet ring protection scheme. In the present invention, two or more rings are used to transport packets in a metropolitan area network. A primary ring is designated as being the ring upon which a flow is sent unless a failure occurred, which prevents that packet from reaching its destination node on the primary ring. A secondary ring is one of the other rings (typically a counter-rotating ring) upon which the flow can be switched by the source node in the event of failure to the primary ring. In a normal mode of operation, both the primary and secondary rings are functioning properly and are used to transport packets. However, if there is a failure on the primary ring, this failure is broadcast to all nodes, identifying the failed connection. These nodes then immediately redirect the flows that are affected by the ring failure onto the secondary ring. When the failure condition is removed, all sources can then switch their redirected flows back on to the primary ring.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a simple prior art packet-switched network.

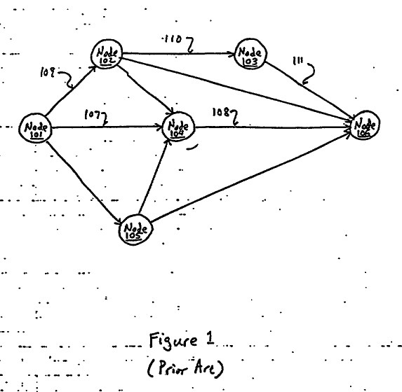

FIG. 2 shows a simple prior art ring topology.

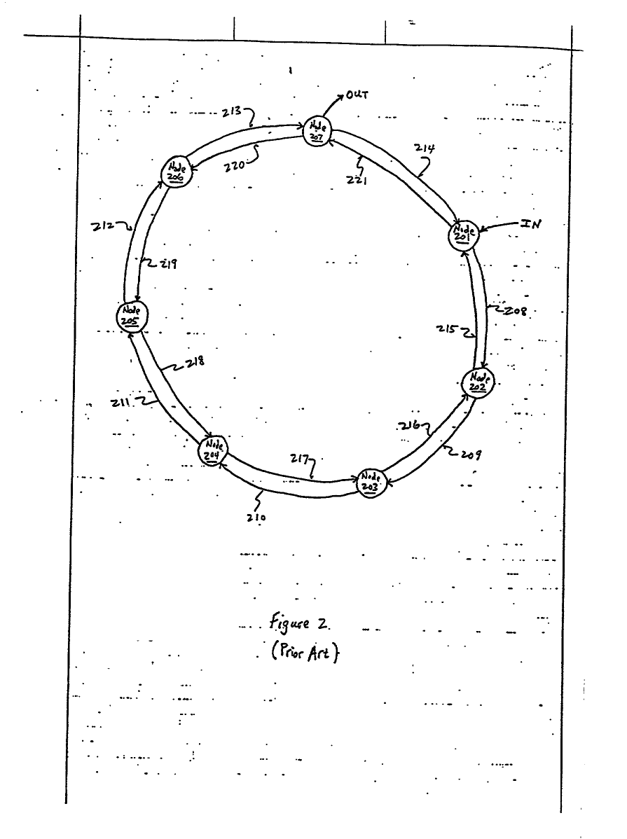

FIG. 3 shows the flow path for handling a failure according to the prior art BLSR scheme.

FIG. 4 shows an exemplary bi-directional flow-switched ring according to the currently preferred embodiment of the present invention.

FIG. 5 shows the flow according to the BFSR scheme of the present invention in the case of a network failure.

FIG. 6 is a flowchart describing the currently preferred method of performing the switch-over according to the present invention.

FIG. 7 shows a packet network having a primary and secondary ring.

FIG. 8 is a flowchart describing the flow redirection process.

FIG. 9 shows the block diagram of the currently preferred embodiment of a metropolitan packet switch (MPS) upon which the present invention may be practiced.

### DETAILED DESCRIPTION

A packet network having a bi-directional flow-switched ring is described. In the following description, for purposes of explanation, numerous specific details are set forth in order to provide a thorough understanding of the present invention. It will be obvious, however, to one skilled in the art that the present invention may be practiced without these specific details. In other instances, well-known structures and devices are shown in block diagram form in order to avoid obscuring the present invention.

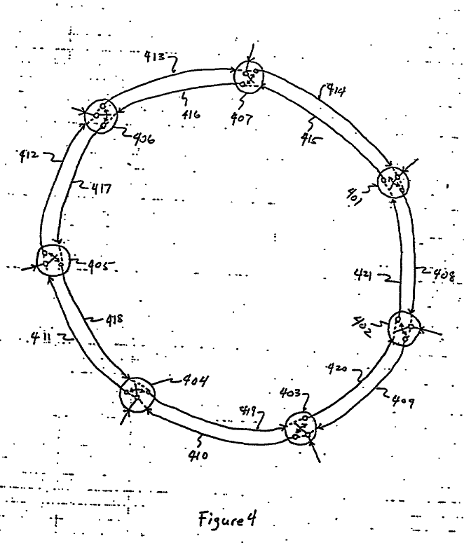

FIG. 4 shows an exemplary bidirectional flow-switched ring according to the currently preferred embodiment of the present invention. As shown, two counter-rotating rings are used to transmit packets from one network element to an adjacent network element. The clockwise ring is comprised of segments 408-414; the counter-clockwise ring is comprised of segments 415-421. In this manner, node 401 can transmit a data packet to node 407 via nodes 402-406 over clockwise ring segments 408-413. Likewise, node 407 can transmit packets to node 401 via nodes 406-402 over counter-clockwise ring segments 416-421. However, in the present invention, any of the network elements 401-407 has the ability to detect a failure condition. And once a failure condition is detected, the failure condition is broadcast to all the nodes. As shown, each node has the capability to selectively switch a data packet immediately over onto a different ring. In other words, each node can receive a data packet from either of the two counter-rotating rings and transmit that data packet out onto either of the two counter-rotating rings.

The significance of immediately switching over to a secondary ring in case of a failure in the primary ring is that it offers several advantages over the prior art bidirectional line-switched ring (BLSR) scheme. First, the bi-directional flow-switched ring (BFSR) scheme of the present invention is much faster than that of the prior art. In the prior art, a data packet would necessarily have to travel through several nodes and segments before being looped back through a different ring. This longer distance and switching overhead unduly increases the associated delay in re-routing a data packet in case of a failure. In contrast, the present invention immediately re-directs a data packet onto a different ring, thereby saving time.

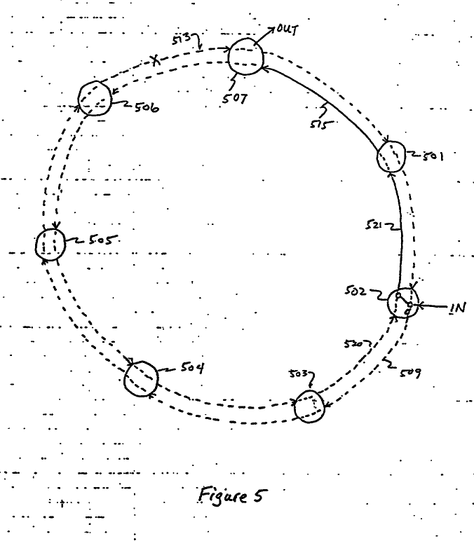

FIG. 5 shows the flow according to the BFSR scheme of the present invention in the case of a network failure. Suppose that an a packet is input to node 502 and destined for output on node 507, and there happens to be a failure in link 513. The failure is detected and immediately broadcast to all nodes. Upon receipt of this failure notification, node 502 immediately switches the packet onto link 521 for transmission to node 501. Node 501 examines then forwards the data packet to node 507 via counter-clockwise segment 515. In short, the data packet is routed through only three nodes and two network segments. Thereby, the present invention achieves the same function as that of the prior art but with far fewer nodes and less segment traversals. As such, the present invention can recover from a failure much faster than that of the prior art. In practice, the prior error handling scheme can take upwards of 50 milliseconds, whereas the present invention takes only 3 or 4 milliseconds. This reduction in time is of critical importance when handling real-time applications, such as voice, control data, streaming audio/video, etc.

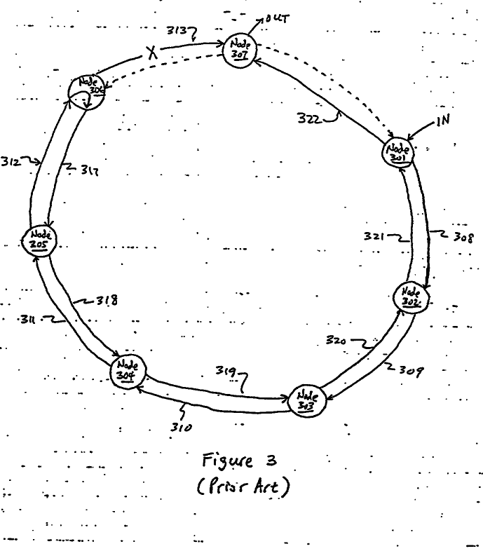

Another advantage of the present invention over that of the prior art is that the present invention reduces the overall congestion on the two rings. Because the present invention entails re-routing data packets through fewer segments and fewer nodes than that of the prior art, there is less traffic being conveyed through those other parts of the nodes and rings. The reduced traffic on those parts of the network frees up available bandwidth. It should be noted that although data packets are re-routed to another ring due to a failed segment, the other segments of the ring can nonetheless be used quite effectively to convey data packets. Referring back to FIG. 3, it can be seen that node 303 can transmit data packets to node 305 via the clockwise segments 310-311 and node 304, even though clockwise segment 313 has failed. And because data packets originating from node 302 and destined for node 307 are not being conducted through segments 310 and 311, this essentially frees up those segments so that they can be used to carry other data packets. Essentially, the overall network bandwidth is improved.

The present invention also has the added benefit of not having the same data packets pass through any given node. In the prior art, a node may receive a data packet, pass that data packet downstream, only to encounter a failed link. The data packet is then re-routed on the other ring and eventually is received by the same node. This same node encounters the same data packet twice. The same nodes see the same packets twice. This packet duplication may lead to complications in hardware and/or software design. With the present invention, any given node will only see a packet once, thereby avoiding this potential problem.

In addition, the present invention can selectively decide on the protection scheme on a per flow basis. Some applications are critical. As such, those flows which are mission critical, are granted full failure protection. Their packets are immediately redirected to the working ring and sent on to their final destination with full quality-of-service (QoS) guarantee. Other applications are not as mission critical. These packets are afforded a lesser degree of protection. They can be redirected on a best-effort basis with no QoS or other bandwidth guarantee. Alternatively, they may be queued and then switched. Still other applications can have no failure protection. If there happens to be a downed segment, some packets are not redirected; these applications lose their ability to reach their intended destination until the failure has been fixed. By offering this selective protection scheme, service providers may vary the fees they charge certain clients accordingly.

In the currently preferred embodiment of the present invention, data packets are protected on a per flow basis. A per flow packet transport ring upon which the present invention may be practiced is described in the patent application entitled, “Per-Flow Rate Control For An Asynchronous Metro Packet Transport Ring,” filed Jun. 30, 2000, Ser. No. 09/608,489, which is incorporated by reference in its entirety herein. The network nodes referenced above are comprised of metropolitan packet switches, such as the ones described in the patent application Ser. No. 09/698,489. Furthermore, the data packets can be afforded different quality of service with different levels of failure protection. The patent application entitled, “Guaranteed Quality of Service In An Asynchronous Metro Packet Transport Ring,” filed Jun. 30, 2000, Ser. No. 09/608,747, describes one such QoS scheme and is incorporated by reference in its entirety herein. Furthermore, in one embodiment, the present invention can be used to re-route data packets so as to avoid those segments which are overly congested or are nearing saturation. In other words, rather than switching rings due to a segment failure, the present invention can switch rings as a function of traffic on certain ring segments. This bandwidth reallocations can be performed according to a weighted scheme, such as the one described in the patent invention entitled, “A Method And System For Weighted Fair Flow Control In An Asynchronous Metro Packet Transport Ring Network,” filed Jul. 6, 2000, Ser. No. 09/611,180, which is incorporated by reference in its entirety herein.

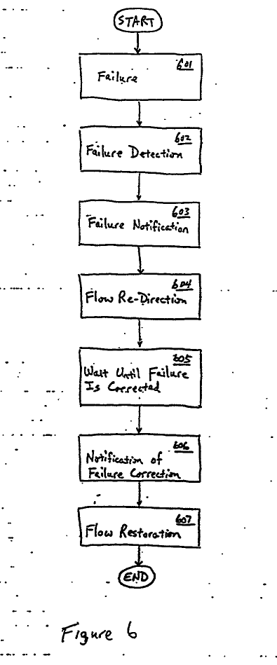

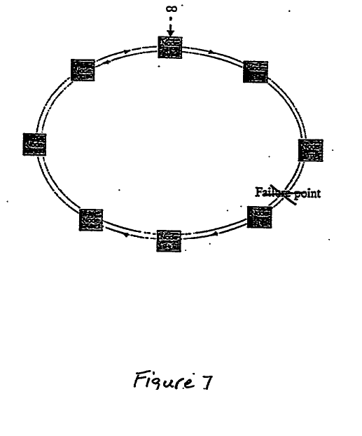

FIG. 6 is a flowchart describing the currently preferred method of performing the switch-over according to the present invention. The process is described with reference to the network of FIG. 7. The primary ring is defined as a ring on which a flow is sent unless a failure occurred preventing it from reaching its destination node. A secondary ring is the other ring (one of the dual counter-rotating rings) on which the flow can be switched to in the event of failure to the primary ring. In a normal mode of operation, both the primary and secondary rings are functioning properly. However, if there is a failure, step 601, then steps 602-607 are performed. A failure can occur if, for instance, the transmission from node m to node n on the clock-wise ring fails. This may be due to a node failure, an interface failure, a link failure, a fiber cut, etc. In step 602, the failure is detected. One indication of a failure is if node n does not receive a heart beat (i.e., keep alive) from node m, thereby indicating a failure. A heartbeat is used in this case as a unified mechanism to detect ring failure. The next step is failure notification, step 603. After detecting the failure, node n immediately broadcasts failure notification message using a RUP (rate update packet). Within the RUP, the message identifies that the failed connection. When the notification reaches node I (or any other source node), the node immediately redirecting the flows that are affected by the ring failure, step 604. The flows continue to be redirected until the failure is corrected, step 605. When the failure condition is corrected, a notification is sent to all nodes that the failure has been fixed, step 606. At that point, all nodes can switch their redirected flows back on to the primary ring, step 607. This step is known as flow reverting or flow restoration.

FIG. 7 shows a packet network having a primary and secondary ring.

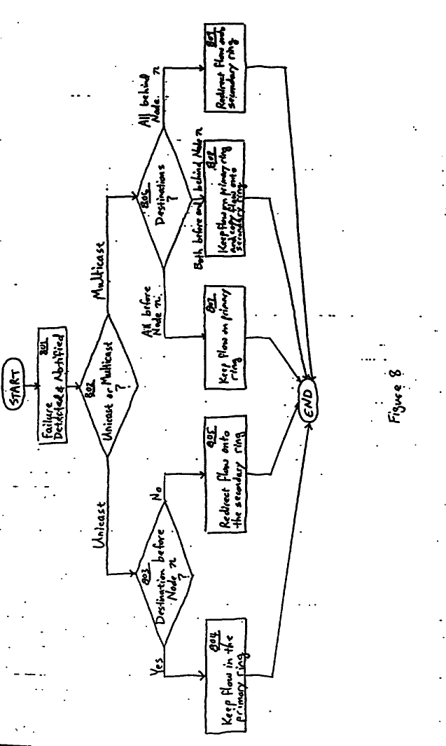

FIG. 8 is a flowchart describing the flow redirection process. Once the failure has been detected and a notification of this failure has been sent, step 801, the flows must then be re-directed. In step 802, a determination is made as to whether the flow is unicast or multicast. If the flow is unicast, steps 803-805 are performed. If the flow in multicast, then steps 806-809 are performed. For unicast flows, step 803 makes a determination as to whether the flow's destination is before a failed node or a node immediately next to a failed segment. If the flow destination is before this node, then the flow is kept on the primary ring (no redirection), step 804. Otherwise, the flow is redirected onto the secondary ring (counter clockwise ring), step 805. In the case of a multicast flow, step 806 determines the destinations of that flow. If all destinations are before a failed node or a node immediately next to a failed segment, then the flow is kept on the primary ring, step 807. If all destinations are behind this node, then the flow is redirected onto the secondary ring, step 809. Otherwise, if the destinations are both before and behind this node, the flow is kept on the primary ring but also copied onto the secondary ring as well, step 808. In one embodiment, the nodes on the ring can be numbered to make it easier for flow redirection decision.

In the process of restoring flows, it should be noted that depending on the distance difference between source and destination on the primary ring and on the secondary ring, the reverted packet on the primary ring can race the packets on the secondary ring, arriving at the destination before the secondary ring packet. Unfortunately, this can cause out of order packet arrival at the final destination. Out-of-order arrival is known to cause undesirably low throughput to TCP flows. Packet bleeding is a novel technique to prevent out-of-order arrival in the event of flow reverting. The technique works as follows. An originating node must wait for at least the ring delay after the sources are instructed to revert their flows before restoring the connection to the primary node. During the this time, the originating node must drop all in-transit packets to prevent them from racing with on-flight packets on the secondary ring, thereby eliminating out-of-order arrival at all destination nodes.

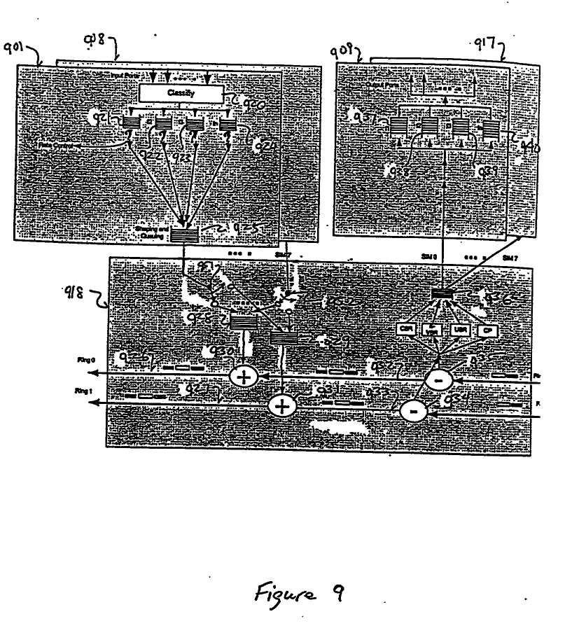

FIG. 9 shows the block diagram of the currently preferred embodiment of a metropolitan packet switch (MPS) upon which the present invention may be practiced. The MPS is comprised of a number of input port modules 901-908 and output port modules 909-917 coupled to an application specific integrated circuit (ASIC) 918. An input port module accepts a number of incoming flows and classifies each flow per classifier circuit 920. Each flow has its own buffer (e.g., buffers 921-924) for queuing the data associated with each flow. Each buffer has an associated rate controller which varies the rate of the flow coming out from that particular buffer. The rate is controlled on a per-flow basis. After rate control, the data output from each of the buffers are then collectively stored in another buffer 925 which is used to perform the functions of rate shaping and queuing. The data is then eventually output from buffer 925 to either of the two FIFO's (first-in-first-out buffers) 928 or 929 according to switch 951.

FIFO 928 is used to collate all the data originating from the input modules 901-908 for outputting onto fiber ring loop 926. An inserter 330 inserts the data output from buffer 928 with the upstream data on segment 932. Similarly, FIFO 929 collates all the data output from the input modules 901-908 for outputting onto fiber ring loop 927. Inserter 931 inserts the data from buffer 329 with the upstream data on segment 933. Switch 951 is controlled such that the flows accepted from each of the input ports can selectively be sent onto either of the two fiber loops 926 or 927.

A separate switch is used to control the flows for each of the modules such that the flows can either be queued onto FIFO 928 or FIFO 929 for transmission on either of the two fiber loops 926 or 927. For example, input module 908 has an corresponding switch 952 which directs particular flows into either FIFO 928 or FIFO 929. Suppose that fiber ring 926 has failed. Switch 952 can be controlled to direct flows to FIFO 929 rather than the normal data path of FIFO 928. Thereby, the flows will be switched over to fiber ring 927 in lieu of the failed fiber ring 926. If the failure has been fixed, switch 952 can be commanded to restore flows back to their default FIFO 928.

The MPS examines each data packet incoming on fiber loops 926 and 927. If a particular data packet is destined to one of the output ports associated with the MPS, then that data packet is pulled out from the fiber loop. Removal circuit 934 removes appropriate data packets from fiber loop 927, and removal circuit 935 removes appropriate data packets from fiber loop 926. Buffer 936 sends the data packets pulled from the fiber loops 926 and 927 to the appropriate output port modules 909-917. Once an output module accepts a data packet, that data packet is queued in one of the buffers 937-940. Data packets are output from the data output modules on a per-flow basis.

It should be noted that the present invention can be applied to multiple rings (e.g. 2,3,4, etc.). These rings can be any combination of clockwise and/or counter-clockwise rotation. Furthermore, the present invention can be used to switch packets to different channels. These channels can exists in the same physical medium or different physical medium. Packets can be switched between different lambdas within the same fiber. For instance if one of the lambdas is down due to a defective laser, the present invention can be used to switch packets onto a secondary lambda. This secondary lambda can be on the same fiber strand or on a different fiber strand.

Thus, a bi-directional flow-switched packet ring protections scheme has been disclosed. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A metropolitan area packet network, comprising:
a first ring for transporting packets in a clockwise direction;
a second ring for transporting packets in a counter-clockwise direction;
a plurality of network nodes coupled to the first ring and the second ring;
a detector residing within each of the nodes which detects a failure in a segment of either of the first ring and second ring;
a switch-over circuit residing within one of the nodes which switches data packets from one ring having a detected failed segment to another ring.

2. The metropolitan area network of claim 1, wherein a node from where a data packet originates performs a switch-over when the failure is detected.

3. The metropolitan area network of claim 1, wherein a node accepts a data packet from the first ring and transfers the data packet out on the second ring in response to the failure.

4. The metropolitan area network of claim 1, wherein the first ring and the second ring comprise a bi-directional flow-switched ring.

5. The metropolitan area network of claim 1, wherein data packets are routed on a per-flow basis.

6. The metropolitan area network of claim 1, wherein data packets are switched over from one ring to another ring in response as a function of congestion on a particular ring segment.

7. The metropolitan area network of claim 1, wherein different degrees of protection are enabled.

8. The metropolitan are network of claim 1, wherein a unicast flow having a destination before a failed node is not redirected by keeping the flow in the first ring and a unicast flow having a destination after a failed node is protected by redirecting that flow onto the second ring.

9. The metropolitan area network of claim 1, wherein a multicast flow is redirected by:
keeping the multicast flow on the first ring if all destinations occur before a failed node;
redirecting the multicast flow onto the second ring if all destinations occur after the failed node;
keeping the multicast flow on the first ring and copying the multicast flow onto the second ring if destinations occur both before and behind the failed node.

10. The metropolitan area network of claim 1, wherein at least one of the network nodes performs packet bleeding to prevent out-of-order packet arrival at a destination node when flows are restored back to their primary ring.

11. In a network having at least two packet rings and a plurality of switching devices coupled to the two packet rings, a method of transmitting packets between the switching devices, comprising the steps of:
transmitting packets in a clockwise direction in a first ring;
transmitting packets in a counter-clockwise direction in a second ring;
detecting when a failure has occurred in a segment of either of the first ring or the second ring;
switching a packet to an operational ring in response to detection of the failure.

12. The method of claim 11 further comprising the step of the switching device immediately switching an originating packet to the operational ring when the failure is detected.

13. The method of claim 11 further comprising the steps of:
accepting the packet from an upstream switching device;
transferring the packet from the first ring for output on the second ring in response to a failure detected on the first ring.

14. The method of claim 12, wherein the first ring and the second ring comprise a bi-directional flow-switched ring.

15. The method of claim 11, wherein data packets are routed on a per-flow basis.

16. The method of claim 11, wherein data packets are switched over from one ring to another ring in response as a function of congestion on a particular ring segment.

17. The method of claim 11, wherein different degrees of protection are enabled.

18. The method of claim 11 further comprising the steps of:
keeping the unicast flow in the first ring;
redirecting a unicast flow having a destination after the failed node by redirecting that flow onto the second ring.

19. The method of claim 11 further comprising the step of re-directing a multicast flow:
keeping the multicast flow on the first ring if all destinations occur before a failed node;
redirecting the multicast flow onto the second ring if all destinations occur after the failed node;
keeping the multicast flow on the first ring and copying the multicast flow onto the second ring if destinations occur both before and behind the failed node.

20. The method of claim 11 further comprising the step of performing packet bleeding to prevent out-of-order packet arrivals at a destination node when flows are restored back to their primary ring.

21. A metropolitan area packet network, comprising:
a fiber optic ring for transporting packets, wherein the fiber ring comprises a plurality of lambdas;
a plurality of network nodes coupled to the fiber optic ring;
a detector residing within each of the nodes for detecting a failure;
a switch residing within one of the nodes which redirects data packets from a first lambda to a second lambda if a failure corresponding to the first lambda is detected.
